(19) United States
(12) Patent Application Publication
(10) Pub. No.: US 2025/0265949 A1
(43) Pub. Date: Aug. 21, 2025

(54) Multifunctional Stop-Sign Device

(71) Applicant: Robert Rodriguez, Miami, FL (US)

(72) Inventor: Robert Rodriguez, Miami, FL (US)

(21) Appl. No.: 19/059,073

(22) Filed: Feb. 20, 2025

Related U.S. Application Data
(60) Provisional application No. 63/555,670, filed on Feb. 20, 2024.

(51) Int. Cl. G09F 9/30; E01F 9/30; E01F 9/692; G09F 7/18

(52) U.S. Cl. CPC G09F 9/30; E01F 9/30; E01F 9/692; G09F 7/18; G09F 2007/1878

(57) ABSTRACT

The multifunctional and smart stop-sign device is a device intended to provide connectivity, security, alerts, notices etc. based on a specific range of operation. Accordingly, the device is a mobile stop-sign device that may be dispatched to environmentally impacted communities to function as a beacon for security, connectivity and environmental notices. In this use the device would only be a temporary sign installed for the benefit of assisting impacted communities in their recovery efforts. To accomplish this the device includes a stop-sign symbol with an enclosure that contains an electrical and electronic system and a power device. Further, the device may be solar powered, may record suspicious activities, highlight suspicious vehicles and provide backup Wi-Fi in the event of a power shortage and perform many other functions. Furthermore, the device includes satellite connectivity that helps with GPS positioning services/alerts as well as surveillance related services.

### FIELD OF THE INVENTION

The present invention relates generally to stop signs. More specifically, the present invention is a stop sign device that can function as a beacon of security, connectivity and environmental notices as well as other functions.

### BACKGROUND OF THE INVENTION

Ever since its premier in 1920 in Detroit, Michigan, the stop sign has become as commonplace as water in the U.S. and around the world. However, for nearly 100 years, little to no innovation or invention has taken place to connect modern day needs with the ever-present stop sign. The present invention is the next generation transformational evolution to the ubiquitous stop sign.

An objective of the present invention is to provide users with a multifunctional and mobile stop-sign device that can provide connectivity, security, alerts, notices etc.

based on a specific range of operation. As climate change continues to wreak havoc on communities, a mobile STOP-sign device and or its equivalent may be dispatched to impacted communities to function as a beacon for security, connectivity and environmental notices. In this use the stop-sign device would only be a temporary sign installed for the benefit of assisting impacted communities in their recovery efforts. Further, the present invention may be solar powered, may record suspicious activities, highlight suspicious vehicles and provide backup Wi-Fi in the event of a power shortage and perform many other functions.

### SUMMARY OF THE INVENTION

The present invention is a multifunctional and smart stop-sign device, that is intended to provide connectivity, security, alerts, notices etc. based on a specific range of operations. Accordingly, the present invention is a mobile STOP-sign device that may be dispatched to calamity-impacted communities to function as a beacon for security, connectivity and environmental notices. In this use the present invention would only be a temporary sign installed for the benefit of assisting impacted communities in their recovery efforts. However, the stop-sign device may be permanently mounted on roadsides as well. Further, the present invention may be solar powered, may record suspicious activities, highlight suspicious vehicles and provide backup Wi-Fi in the event of a power shortage and many other functions. Furthermore, the present invention comprises satellite connectivity that helps with GPS positioning services/alerts as well as surveillance related services. To accomplish this the present invention comprises a stop-sign symbol or signage with an enclosure that contains an electrical and electronic system including a power device.

### BRIEF DESCRIPTION OF THE DRAWINGS

FIG. 1 is a is a top-front-left perspective view of the present invention.

FIG. 2 is an exploded top-front-left perspective view of the present invention.

FIG. 3 is a system diagram of an electrical and electronic system according to a preferred embodiment of the present invention, wherein thinner lines depict electrical connections, thicker lines depict electronic connections, and broken lines depict wireless connections between components of the present invention.

FIG. 4 is an exploded top-rear-left perspective view of the present invention.

FIG. 5 is a front elevational view of the present invention.

FIG. 6 is a rear elevational view of the present invention.

FIG. 7 is right side elevational view of the present invention.

FIG. 8 is a rear elevational view of an alternate embodiment of the present invention, wherein a visual output system is shown.

### DETAILED DESCRIPTION OF THE INVENTION

All illustrations of the drawings are for the purpose of describing selected versions of the present invention and are not intended to limit the scope of the present invention.

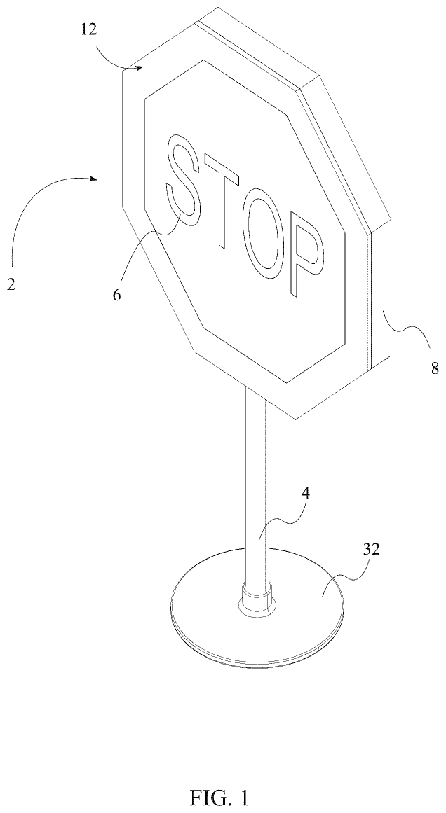

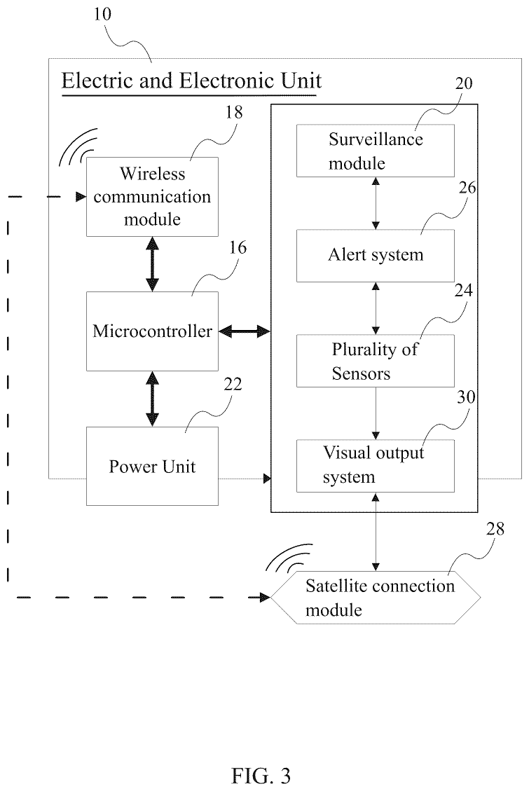

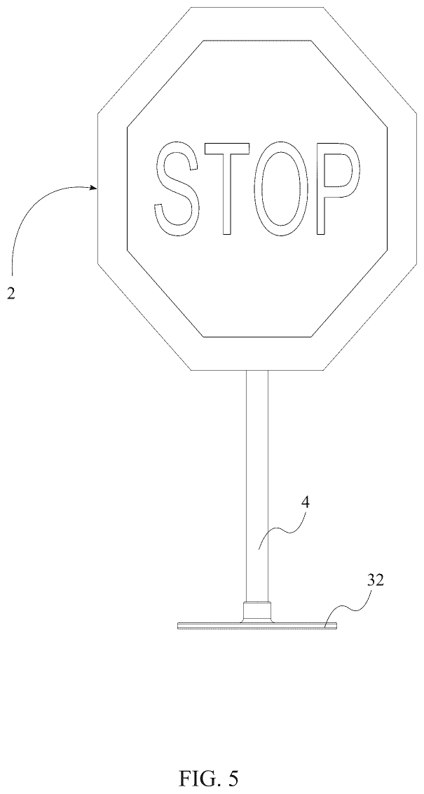

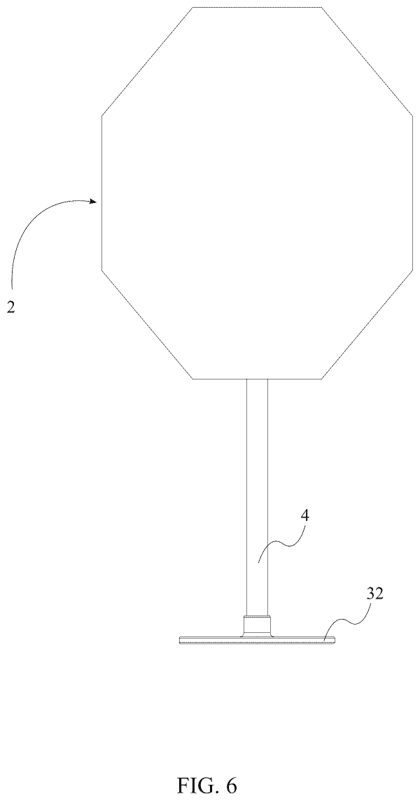

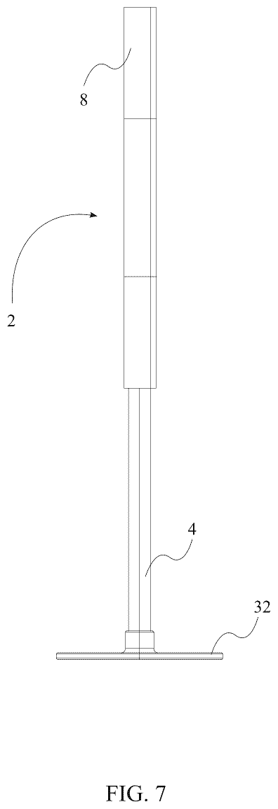

In reference to FIG. 1 through FIG. 8, the present invention discloses a smart stop-sign device.

The following description is in reference to FIG. 1 through FIG. 8. According to a preferred embodiment, the present invention comprises a signage head 2, a pole 4, a stop-sign symbol 6, an enclosure 8, and an electronic unit 10. Preferably, the signage head 2 is an octagonal flat board that is made of a sturdy and weatherproof material such as a metal such that the signage head 2 may carry an important sign that is visible to drivers and pedestrians passing through a location where the signage head 2 is mounted. Further, in the preferred embodiment, the signage head 2 comprises a first head surface 12 and a second head surface 14, wherein the first head surface 12 is positioned opposite to the second head surface 14 across the signage head 2. In other words, the first head surface 12 constitutes a front surface of the signage head 2, and the second head surface 14 constitutes a rear surface of the signage head 2. The pole 4 is the supporting structure that holds the signage head 1 at a height above the ground, such that people inside a vehicle and pedestrians who pass the location through which the stop-sign device is mounted, may read the sign clearly. To that end, the signage head 2 is mounted onto a terminal end of the pole 4 opposite from the ground. Preferably, the pole 4 is a long cylindrical structure that is sturdy enough to hold the signage head 2 upright, even in in adverse weather conditions, such as during heavy winds and rains. However, the signage head 2 and the pole 4 may comprise any other shape, size, material, components, arrangement of components etc. that are known to one of ordinary skill in the art, as long as the intents of the present invention are fulfilled. Further, the pole 4 may be fastened to the signage head 2 using any kind of fasteners such as nuts and bolts or using any other fastening technology that is known to one of ordinary skill in the art, as long as the intents of the present invention are not altered. Furthermore, the stop-sign symbol 6 is superimposed onto the first head surface 12, wherein the first head surface 12 is oriented towards a street with an incoming traffic.

It is an objective of the present invention to provide a smart stop-sign device that can aid with connectivity, surveillance, and security to people within a community or neighborhood associated with the stop-sign device location. To accomplish this, the enclosure 8 is mounted onto the second head surface 14 and the electronic unit 10 is mounted within the enclosure 8. Preferably, the enclosure 8 is a receptacle that mimics the shape of the signage head 2 and has a width enough to house the electronic unit 10, such that the electronic unit 10 is protected from external elements and adverse weather conditions.

In order to accomplish the intended functionalities of the present invention, the electronic unit 10 comprises a microcontroller 16, a wireless communication module 18, a surveillance module 20, and a power unit 22. The microcontroller 16 is a processing device that manages the operation of the electrical components within the present invention. Thus, according to the preferred embodiment, the wireless communication module 18 and the surveillance module 20 are electronically connected to the microcontroller 16. The wireless communication module 18 connects and communicates with external devices via wireless data transmission protocols. Example standards of what the wireless communication module is capable of using include, but are not limited to, Bluetooth, WI-FI, GSM, CDMA, ZigBee, etc. In the preferred embodiment, the wireless communication module 20 may provide backup Wi-Fi in the event of a power shortage. Preferably, the surveillance module 20 is a biometric surveillance system, such that the biometric capabilities such as reading the number of a car, checking the speed etc. may be integrated into the device. This is helpful for generating data of traffic along a specific road or area and identifying specific traffic, such as uber drivers, package delivery carriers etc. This generated data becomes useful for local communities to make changes or include restrictions or new pathways. However, it should be noted that the surveillance module 20 and the wireless communication module 18 may comprise any other features, components, arrangement of components, etc. that are known to one of ordinary skill in the art, as long as the intents of the present invention are not altered.

In order to provide electrical power to the components of the present invention, the power unit 22 is electrically connected to the microcontroller 16, the surveillance module 20, and the wireless communication module 18. Preferably, the power source 22 is a solar power converter charged by a solar panel located within the vicinity of the present invention. However, any other source of power, or a combination of the following sources may be employed as the power unit 22 for the smooth functioning of the stop-sign device. Examples of such power sources include, but are not limited to, Li ion batteries, magnetic power converters, rechargeable batteries, external power terminals, etc.

A more detailed description of the present invention continues. It is an aim of the present invention to provide weather alerts and communicate other important alerts within a neighborhood or within a location where the device is mounted. To that end, the electronic unit 10 further comprises a plurality of sensors 24, wherein the plurality of sensors 24 is electronically connected to the microcontroller 16. Preferably, the plurality of sensors 24 include weather sensors or environmental sensors. This is so that the stop-sign device could monitor air quality, temperature, humidity, etc. Further, in an alternate embodiment, if weather conditions become hazardous (e.g., poor visibility due to fog), the stop-sign device could send alert signals and/or display relevant safety messages, through an LED light system integrated onto the signage head 2.

Continuing with the preferred embodiment, the present invention intends to provide alert signals or transfer alert messages at multiple situations. Accordingly, the electronic unit 10 further comprises an alert system 26, wherein the alert system 26 is electronically connected to the microcontroller 16. This is so that the stop-sign device could display real-time emergency alerts such as weather warnings, traffic accidents or road closures, thereby keeping drivers informed and safe. To that end, the alert system is operatively coupled to the surveillance module 20 and the plurality of sensors 24, wherein the surveillance module 20 and the plurality of sensors 24 actuate the alert system 26 by sending an alert signal through the microcontroller 16. In one embodiment, the alert signal may be an audio alarm. In an alternate embodiment, the alert signal may be a visual signal such as a light signal or an alert message.

In order to provide GPS (Global Positioning System) and navigation features, the wireless communication module 18 further comprises a satellite connection module 28, wherein the satellite connection module 28 is electronically connected to the microcontroller 16. Thus, the integrated GPS and navigation features could guide lost drivers or provide alternate routes when roads are blocked.

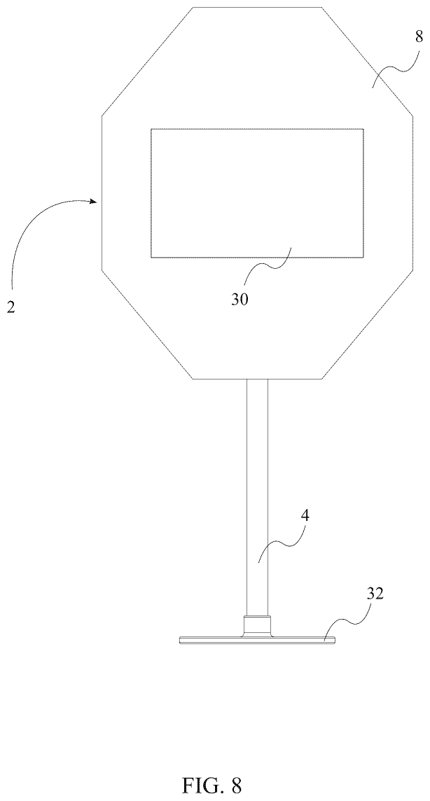

In an alternate embodiment, and in reference to FIG. 8, the present invention may comprise a visual output system 30, wherein the visual output system 30 is mounted adjacent to the second head surface 14, and onto an external surface of the enclosure 8. Preferably, the visual output system 30 is positioned opposite to the stop-sign symbol 6, across the signage head 2, such that stop functionality is not affected by the visual being displayed by the visual output system 30. The visual output system 30 may display ads, additional lights, or messages that does not hinder with the smooth movement of traffic. Further, the visual output system 30 is electronically connected to the microcontroller 16.

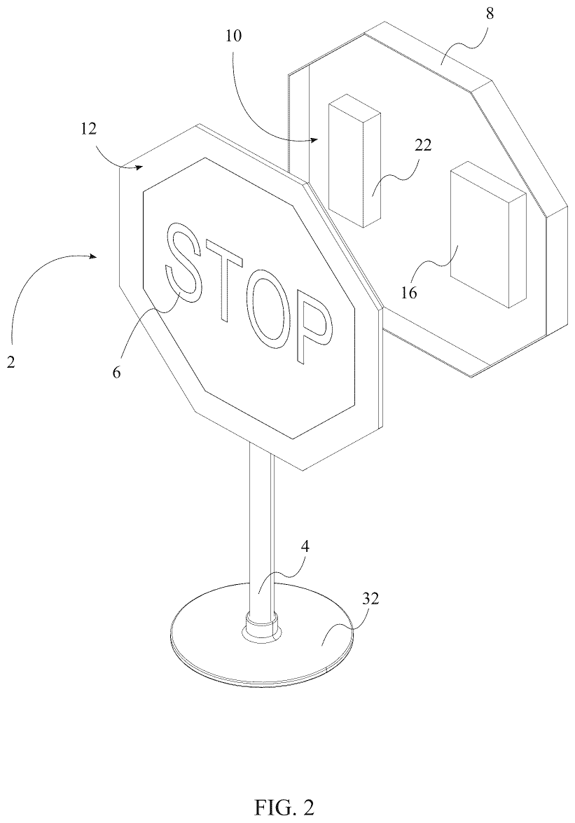

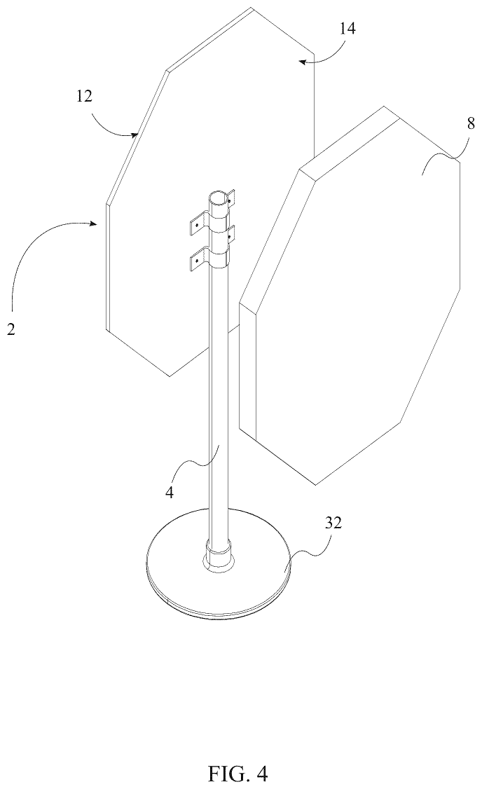

As seen in FIG. 1 and FIG. 2 and in FIG. 4 through FIG. 8, the present invention comprises a base 32, wherein the base 32 forms the support structure that connects the pole 4 to the ground permanently or temporarily. Accordingly, the pole 4 is terminally mounted onto the base 32. In the preferred embodiment, the base 32 is a circular structure onto which the pole 4 is centrally mounted. However, the base 32 may include any other shape, size, material, etc. that are known to one of ordinary skill in the art.

Furthermore, it should be noted that any other electrical components such as wires, chips, lights, etc. as well as any other physical features such as apertures, supporting structures, etc. fall under the scope of the present invention, as long as the objectives of the present invention are not hindered.

Although the invention has been explained in relation to its preferred embodiment, it is to be understood that many other possible modifications and variations can be made without departing from the spirit and scope of the invention as hereinafter claimed.

What is claimed is:

1. A multifunctional stop-sign device comprising:
a signage head;
a pole;
a stop-sign symbol;
an enclosure;
an electronic unit;
the electronic unit comprising a microcontroller, a wireless communication module, a surveillance module, and a power unit;
the signage head comprising a first head surface and a second head surface;
the first head surface being positioned opposite to the second head surface across the signage head;
the stop-sign symbol being superimposed onto the first head surface;
the signage head being mounted onto a terminal end of the pole;
the enclosure being mounted onto the second head surface;
the electronic unit being mounted within the enclosure;
the wireless communication module and the surveillance module being electronically connected to the microcontroller; and
the power unit being electrically connected to the microcontroller, the surveillance module, and the wireless communication module.

2. The multifunctional stop-sign device of claim 1 comprising
the electronic unit further comprising a plurality of sensors; and
the plurality of sensors being electronically connected to the microcontroller.

3. The multifunctional stop-sign device of claim 2, wherein the plurality of sensors are weather sensors.

4. The multifunctional stop-sign device of claim 2 comprising:
the electronic unit further comprising an alert system;
the alert system being electronically connected to the microcontroller; and
the alert system being operatively coupled to the surveillance module and the plurality of sensors, wherein the surveillance module and the plurality of sensors actuate the alert system by sending an alert signal through the microcontroller.

5. The multifunctional stop-sign device of claim 1 comprising:
the wireless communication module comprising a satellite connection module; and
the satellite connection module being electronically connected to the microcontroller through the wireless communication module.

6. The multifunctional stop-sign device of claim 1 comprising:
a visual output system;
the visual output system being mounted adjacent to the second head surface; and
the visual output system being positioned opposite to the stop-sign symbol, across the signage head.

7. The multifunctional stop-sign device of claim 6, comprising:
the visual output system being electronically connected to the microcontroller.

8. The multifunctional stop-sign device of claim 1, comprising:
a base; and
the pole being terminally mounted onto the base.

9. The multifunctional stop-sign device of claim 1, wherein the power source is a solar power converter.

10. The multifunctional stop-sign device of claim 1, wherein the surveillance module is a biometric surveillance system.

11. The multifunctional stop-sign device of claim 1, wherein the first head surface is oriented towards a street with an incoming traffic.

12. A multifunctional stop-sign device comprising:
a signage head;
a pole;
a stop-sign symbol;
an enclosure;
an electronic unit;
the electronic unit comprising a microcontroller, a wireless communication module, a surveillance module, a plurality of sensors, an alert system, and a power unit;
the signage head comprising a first head surface and a second head surface;
the first head surface being positioned opposite to the second head surface across the signage head;
the stop-sign symbol being superimposed onto the first head surface;
the signage head being mounted onto a terminal end of the pole;
the enclosure being mounted onto the second head surface;
the electronic unit being mounted within the enclosure;
the wireless communication module, the surveillance module, the plurality of sensors and the alert system being electronically connected to the microcontroller;
the alert system being operatively coupled to the surveillance module and the plurality of sensors, wherein the surveillance module and the plurality of sensors actuate the alert system by sending an alert signal through the microcontroller; and
the power unit being electrically connected to the microcontroller, the surveillance module, and the wireless communication module.

13. The multifunctional stop-sign device of claim 12 comprising:
the wireless communication module comprising a satellite connection module; and
the satellite connection module being electronically connected to the microcontroller through the wireless communication module.

14. The multifunctional stop-sign device of claim 12 comprising:
a visual output system;
the visual output system being mounted adjacent to the second head surface; and
the visual output system being positioned opposite to the stop-sign symbol, across the signage head.

15. The multifunctional stop-sign device of claim 14, comprising:
the visual output system being electronically connected to the microcontroller.

16. The multifunctional stop-sign device of claim 12, comprising:
a base; and
the pole being terminally mounted onto the base.

17. The multifunctional stop-sign device of claim 12, wherein the power source is a solar power converter.

18. The multifunctional stop-sign device of claim 12, wherein the surveillance module is a biometric surveillance system.

19. The multifunctional stop-sign device of claim 12. wherein the first head surface is oriented towards a street with an incoming traffic.
